(19) United States
(12) Patent Application Publication
(10) Pub. No.: US 2025/0184788 A1
(43) Pub. Date: Jun. 5, 2025

(54) TECHNOLOGIES FOR OVER-THE-AIR CALIBRATION OF MULTIPLE TRANSMIT-RECEIVE POINT OPERATION

(71) Applicant: APPLE INC., Cupertino, CA (US)

(72) Inventors: Haitong Sun, Saratoga, CA (US); Dawei Zhang, Saratoga, CA (US); Jie Cui, San Jose, CA (US); Wei Zeng, Saratoga, CA (US); Ankit Bhamri, Haar Bavaria-Bayern (DE); Chunxuan Ye, San Diego, CA (US); Weidong Yang, San Diego, CA (US)

(73) Assignee: APPLE INC., Cupertino, CA (US)

(21) Appl. No.: 18/823,548

(22) Filed: Sep. 3, 2024

Related U.S. Application Data
(60) Provisional application No. 63/605,538, filed on Dec. 3, 2023.

(51) Int. Cl. H04W 24/10; H04B 7/06; H04W 72/0453

(52) U.S. Cl. CPC H04W 24/10; H04B 7/0626; H04W 72/0453

(57) ABSTRACT

The present application relates to devices and components, including apparatus, systems, and methods for over-the-air calibration for wireless networks' multiple transmit-receive point (mTRP) operation.

### CROSS-REFERENCES TO OTHER APPLICATIONS

This application claims priority to U.S. Provisional Application No. 63/605,538, for “TECHNOLOGIES FOR OVER-THE-AIR CALIBRATION OF MULTIPLE TRANSMIT-RECEIVE POINT OPERATION,” filed on Dec. 3, 2023, which is herein incorporated by reference in its entirety for all purposes.

### TECHNICAL FIELD

This application generally relates to communication networks and, in particular, to technologies for over-the-air calibration for wireless networks' multiple transmit-receive point (mTRP) operation.

### BACKGROUND

Third Generation Partnership Project (3GPP) Technical Specifications (TSs) provide details of radio interface protocols to facilitate communication over wireless networks. These TSs define mTRP operation in which a serving cell communicates with a user equipment (UE) using two or more transmit-receive points (TRPs). This may improve coverage, reliability, or data rates. Further improvements in mTRP operation are desired.

### BRIEF DESCRIPTION OF THE DRAWINGS

FIG. 1 illustrates a network environment in accordance with some embodiments.

FIG. 2 illustrates a network environment in accordance with some embodiments.

FIG. 3 illustrates an example of a radio resource control information element data structure in accordance with some embodiments.

FIG. 4 illustrates an example of a radio resource control information element data structure in accordance with some embodiments.

FIG. 5 illustrates a timing diagram in accordance with some embodiments.

FIG. 6 illustrates a timing diagram in accordance with some embodiments.

FIG. 7 illustrates an operational flow/algorithmic structure in accordance with some embodiments.

FIG. 8 illustrates an operational flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

3GPP Release 15 (R15) provided specifications to support and enable transparent operation mode for multi-TRP.

3GPP Release 16 (R16) defined: multi-downlink control information (DCI) mTRP in which DCI from two different TRPs independently scheduled PDSCH/PUSCH for respective TRPs; and single-DCI mTRP with respect to PDSCH. The single-DCI would schedule the PDSCH from different TRPs using spatial division multiplexing (SDM), frequency division multiplexing (FDM) (scheme A/B), or time division multiplexing (TDM) (scheme A/B (inter-slot)). Single DCI mTRP operation in R16 is a non-coherent joint transmission (NCJT) scheme.

In non-coherent joint transmission, multiple TRPs send signals to the UE. However, the signals from different TRPs are not phase-aligned. When the signals are not phase-aligned, they may be received at the UE having different phases and may not be coherently combined. In non-coherent joint transmission, each TRP may independently schedule a transmission without exchanging channel state information or scheduling information with other TRPs.

3GPP Release 17 (R17) introduced mTRP for PDCCH transmissions. Some of these aspects included PDCCH repetition via search space linkage and single frequency network (SFN)-PDCCH (scheme A/B). R17 also introduced mTRP for PDSCH transmissions with SFN-PDSCH (scheme A/B). In addition, R17 also introduced mTRP for PUSCH/PUCCH. Some of these aspects include PUSCH TDM repetition and PUCCH TDM repetition.

To support mTRP operation, R17 introduced enhancements to the measurement and report of channel state information (CSI). R17 introduced the Type I codebook for the single-DCI mTRP NCJT SDM scheme.

3GPP Release 18 (R18) introduced support for coherent joint transmission (CJT), e.g., single-DCI mTRP CJT on PDSCH. R18 also introduced simultaneous transmission cross multiple panels (STxMP) on PUSCH, e.g., single-DCI SFN, single-DCI SDM, and multi-DCI schemes. In addition, R18 introduced a single-DCI SFN STxMP scheme for PUCCH.

Multiple TRPs may send signals to the UE in a CJT. The signals from different TRPs are phase-aligned; hence, the term is coherent. When the signals are phase-aligned, they may be received at the UE having the same phase, and therefore, the signals may combine coherently with one another. In non-coherent joint transmission, each TRP may independently schedule a transmission without exchanging channel state information or scheduling information with other TRPs.

R18 introduced CSI enhancement of Type II codebook to support coherent joint transmission for single-DCI mTRP CJT scheme.

Embodiments of the present disclosure describe extensions to the R18 CSI enhancement to enable mTRP CJT operation. The CSI enhancement may enable over-the-air (OTA) calibration of TRPs. The CSI enhancement may include measurement and reporting of frequency offset and time offset between TRPs.

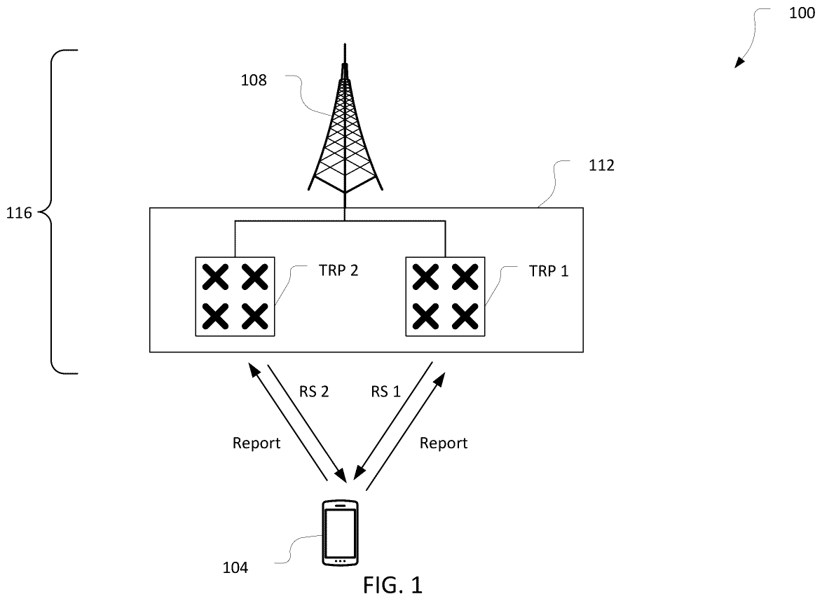

FIG. 1 illustrates a network environment 100 in accordance with some embodiments. The network environment 100 may include a UE 104 and a base station 108. The base station 108 may be coupled with a plurality of TRPs 112 to provide one or more wireless access cells through which the UE 104 may communicate. As shown, the base station 108 may be coupled with two TRPs 112, e.g., TRP 1 and TRP 2. The base station 108 may use the TRPs 112 to provide geographically distributed points of transmission/reception to increase cell coverage and spatial diversity. Each of the TRPs may include a single TRP or a group of TRPs that are generally controlled as a single TRP.

While FIG. 1 illustrates the base station 108 coupled with the two TRPs directly, in other embodiments, more than one base station may be coupled with the two TRPs, and the base stations may communicate with one other over a backhaul link to coordinate communications with the UE 104. The base station 108 and TRPs 112 may be collectively referred to as an access node 116.

The access node 116 may provide an air interface compatible with 3GPP technical specifications, such as those that define Fifth Generation (5G) new radio (NR) or later system standards. Depending on the technology, the base station 108 may be referred to as an eNB, gNB, an ng-NB, etc. The access node 116 may provide the UE 104 access to other networks, for example, a core network, a data network, etc.

The access node 116 may control the uplink and downlink operation through the physical (PHY) layer and media access control (MAC) layer. The configuration information may be provided to the UE 104 by the RRC layer.

Each TRP, e.g., TRP 1 or TRP 2, may transmit a reference signal (RS) to the UE 104. For example, the TRP 1 may send RS 1, and TRP 2 may send RS 2 to the UE 104. The UE 104 may use the received reference signals to measure the frequency offset or timing difference between the two reference signals.

The UE 104 may generate a report based on the measured frequency offset or timing difference between the signals from TRP 1 and TRP 2. The UE 104 may send the report to the access node 116. Access node 116 may use the report to calibrate the transmission parameters, e.g., timing advance, phase or frequency, of one or both TRPs. For example, the access node 116 may calibrate the transmission parameters of TRP 1 or TRP 2 based on coherent joint transmission from TRP 1 and TRP 2 to the UE 104.

The report from the UE 104 may be processed at the base station 108. The base station 108 may send a command to the TRP 1 or TRP 2 to initiate the calibration of transmission parameters at the TRPs. In some instances, the report may be processed at the TRPs, and each TRP may calibrate its transmission parameters accordingly.

Embodiments of the present disclosure describe aspects that provide resources for measurement and reporting of the frequency offset and timing difference at the UE.

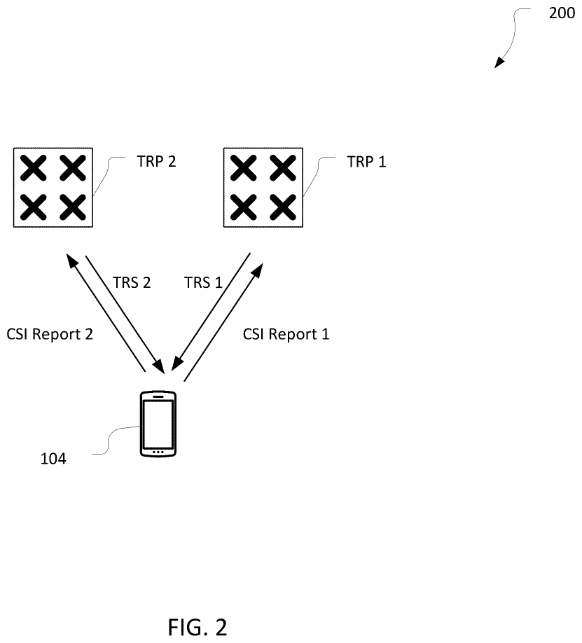

FIG. 2 illustrates a network environment 200 in accordance with some embodiments. Network environment 200 includes two TRPs, TRP 1 and TRP 2. The TRP 1 transmits a tracking reference signal (TRS) 1, and TRP 2 transmits TRS 2 to the UE 104. To facilitate the mTRP operation, especially CJT operation, the UE 104 may measure the frequency offset between TRPs, e.g., TRP 1 and TRP 2, or the downlink (DL) reception timing difference between different TRPs, e.g., TRP 1 and TRP 2. The UE 104 may generate a report based on the measured frequency offset or DL reception timing difference and send the report to the access node, e.g., the base station.

The base station may configure the UE 104 to use channel measurement resource (CMR) configuration for measurement or reporting the frequency offset or the timing difference. For example, a TRS resource or a TRS resource set may be configured for CRM. For example, the TRS resource set may be a non-zero-power (NZP) channel state information (CSI) reference signal (RS) resource set that is configured with higher layers. In one instance, the TRS resource set may be an NZP-CSI-RS resource set configured by the trs-info information element (IE) of RRC signaling.

The base station may configure the UE 104 with the resources for measurement and reporting associated with a reference signal. For example, the base station may configure the UE to perform measurements using CSI-RS and report the results to the network. The base station may use a CSI report configuration message to configure the UE. For example, the base station may use the CSI-ReportConfig IE of RRC signaling to configure the UE.

The UE 104 may measure channel quality indicator (CQI), precoding matrix indicator (PMI), rank indicator (RI), time-domain channel property (tdcp), layer indicator (LI), layer 1 (L1) reference signal received power (RSRP), or L1 signal to interference and noise ratio (SINR) or other quantities.

The base station may configure TRS resource or TRS resource set for CMR using the CSI report configuration. The CSI report configuration may include and configure more than one TRS resource or TRS resource set as CMR. Each TRS resource or TRS resource set may be associated with a TRP or a TRP group. For example, a first TRS resource set may be associated with a first TRP or a first TRP group, and a second TRS resource set may be associated with a second TRP or a second TRP group. A TRP group may be a group of TRPs that has a similar time or frequency offset.

The configured TRS resource set may be a periodic TRS resource set or an aperiodic TRS resource set. The base station may configure the periodic TRS resource set and may include resources periodically allocated to the UE for measuring and reporting channel parameters, e.g., frequency offset or timing difference. The base station may trigger an aperiodic measurement and reporting. For example, the base station may send a DCI that triggers measurement and reporting at the UE. The DCI may include resource sets required for measurement and reporting.

The CSI report configuration may include configuration for multiple resource sets. In one embodiment, all configured TRS resource sets may be expected to have the same time-domain behavior. For example, the CSI report configuration may include only periodic TRS resource sets. Alternatively, the CSI report configuration may include only aperiodic TRS resource sets. In embodiment, the configured resource sets may have different time-domain behavior. For example, the CSI report configuration may include both periodic and aperiodic resource sets.

The UE 104 may be configured with multiple TRS resource sets for CMR in the same CSI report configuration. One or more of the TRS resource sets may be NZP-CSI-RS resource sets. The same CSI resource configuration may include one or more NZP-CSI-RS resource sets. For example, one CSI resource configuration may include one or more periodic NZP-CSI-RS resource sets.

The time domain behavior of the CSI-RS resources within a CSI resource setting, e.g., a CSI report configuration, may be indicated by a higher layer parameter, e.g., resource type, and may be set to aperiodic, periodic, or semi-persistent. For periodic and semi-persistent CSI resource settings, e.g., CSI resource configuration, the number of CSI resource sets configured may be defined by the 3GPP specification or configured by the network.

The CSI report configuration for time or frequency offset reports may include interference measurement resource (IMR) configuration. In another example, the CSI report configuration for time or frequency offset report may not include IMR configuration.

The report carrying timing difference or frequency offset between different TRPs may be reported on PUSCH. In one example, the report may include an aperiodic CSI report on PUSCH or a semi-persistent CSI report on PUSCH activated by DCI. In one example, only an aperiodic CSI report on PUSCH is supported. In one example, only a semi-persistent CSI report on PUSCH that DCI activates is supported.

In another example, the CSI report on PUCCH is supported. For example, periodic CSI reports or semi-persistent CSI reports activated by MAC-CE are supported on PUCCH. In other examples, the CSI report on PUCCH may be restricted to periodic CSI reports or to semi-persistent CSI reports activated by MAC-CE.

In some instances, the transmission of CSI reports (periodic, aperiodic, or semi-persistent) is supported on PUSCH and PUCCH.

The CSI report may be a stand-alone report. The stand-alone report may only carry the timing difference or frequency offset. In other instances, the CSI report may be a non-stand-alone report. The CSI report configuration may simultaneously configure reporting of the timing difference, frequency offset, or other quantities such as L1 RSRP, L1 SINR, CRI, CQI, RI, LI, tdcp, or PMI.

The schedule for transmission of a CSI report that carries timing differences or frequency offset may collide with the schedule for transmission of a CSI report that carries CSI, e.g., tdcp, L1 RSRP, L1 SINR, CRI, CQI, RI, LI, or PMI. The CSI report that carries timing difference or frequency offset may have the same priority as the CSI report that does not include L1 RSRP or L1 SINR. In some instances, the priority of the CSI report that carries timing difference or frequency offset may be lower than the CSI report that does not include L1 RSRP or L1 SINR. The network may configure the UE with priorities associated with CSI reports that carry timing difference or frequency offset between TRPs.

The UE may use differential encoding to compress or encode timing difference or frequency offset between different TRPs. The network may identify a TRP as a reference TRP. Alternatively or additionally, the UE may determine a TRP as a reference TRP and inform the network. For example, the UE may send the index of the reference TRP to the base station. The reference TRP may be defined by the 3GPP specifications. For example, the reference TRP may be defined to be the first TRP, e.g., the first TRS resource set configured as CMR or the TRS resource set with the smallest NSP-CSI-RS resource set ID. The UE may not report the frequency offset or timing offset of the reference TRP.

For the TRPs other than the reference TRP, the UE may report both the sign and the absolute value of the frequency offset or the timing difference. Alternatively, for the TRPs other than the reference TRP, the UE may report only the absolute value of the frequency offset or the timing difference.

The UE may calculate the frequency offset or the timing difference of other TRPs with respect to the reference TRP. The frequency offset is differentially encoded using the difference of the frequency offset of a TRP to the reference TRP. Similarly, the timing offset is differentially encoded using the difference of the timing offset of a TRP to the reference TRP.

The UE may use a linear, equal distance quantization to quantize and encode the absolute value of the frequency offset or timing difference. For example, if N bits are used to quantize a range between 0 and Fₘₐₓ Hz, where Fₘₐₓ is the maximum reportable frequency offset, then the distance between different quantization points is Fₘₐₓ/(2^{N}−1). The largest quantization point, e.g., 2^{N}−1 th point, may be reserved to indicate out-of-range. In one example, the Fₘₐₓ may be a function of the carrier frequency.

Similarly, if M bits are used to quantize a range between 0 and Tₘₐₓ microseconds, where Tₘₐₓ is the maximum reportable time offset, then the distance between different quantization points is Tₘₐₓ/(2^{M}−1). The largest quantization point, e.g., 2^{M}−1 th point, may be reserved to indicate out-of-range. In one example, the Tₘₐₓ may be a function of the cyclic prefix duration.

In another example, when the timing difference is measured in phase, e.g., radians, K bits may be used to quantize the range between 0 and 2·Pi. Where k=ceiling (log₂(O₃N₃)). Where N₃ is the number of frequency domain subbands, and N₃ may be a function of the number of physical resource blocks in the DL BWP, where O₃ is the oversampling factor, e.g., {1, 2, 4}. The distance between different quantization points is 2·Pi/O₃/N₃. One quantization point, e.g., the largest, may be reserved to indicate out-of-range.

The timing difference may be measured in units of time, e.g., microseconds, or in phases, e.g., radians.

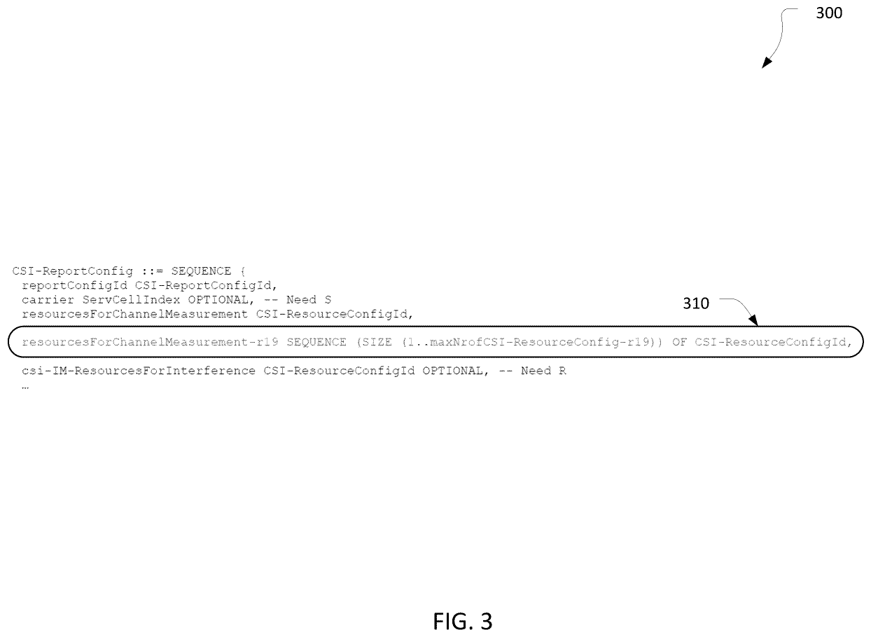

FIG. 3 illustrates an example of a radio resource control information element data structure 300 in accordance with some embodiments. To support UE in measuring and reporting time or frequency offset between different TRPs, TRS resource sets may be configured for CMR in the same CSI report setting, e.g., the same CSI report configuration.

The UE uses CSI report configuration for measuring and reporting CSI parameters to the base station. The base station may use RRC signaling to set CSI report configuration at the UE.

For example, the CSI report configuration may be the RRC information element CSI-ReportConfig 300. The CSI report configuration may include an identifier. For example, CSI-ReportConfigId in CSI-ReportConfig 300 may identify the configuration. The UE may be configured with more than one CSI-ReportConfig each may be identified and distinguished by its associated CSI-ReportConfigId.

The CSI-ReportConfig 300 may include an indication to identify the resources for channel measurement. For example, the CSI-Report Config 300 may include the resourcesForChannelMeasurement-r19 310. When resourcesForChannelMeasurement-r19 with more than one CSI-ResourceConfigId is configured in the same CSI-ReportConfig, all CSI resources associated with the CSI-ResourceConfigId are expected to be configured with the same bandwidth part (BWP) identifier (ID).

In one example, the network may only configure one of the resourcesForChannelMeasurement and resourcesForChannelMeasurement-r19 310.

The network may use the CSI-ReportConfig to configure periodic TRS resource sets.

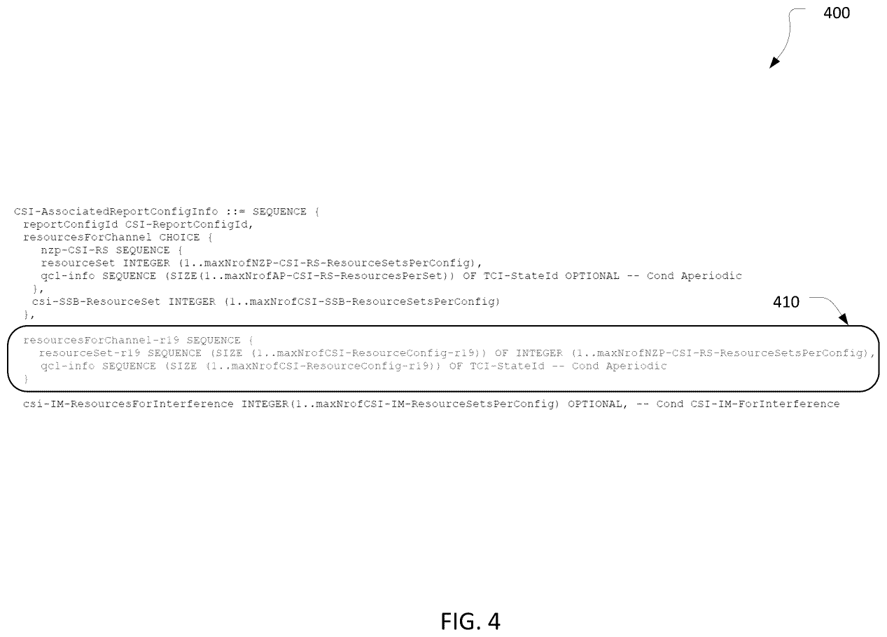

FIG. 4 illustrates an example of a radio resource control information element data structure 400 in accordance with some embodiments. To support UE in measuring and reporting time or frequency offset between different TRPs, TRS resource sets may be configured for CMR in the same CSI report setting, e.g., the same CSI report configuration.

The resources for channel measurement may be configured in an RRC signaling information element. For example, the resources may be configured in a CSI-AssociatedReportConfigInfo 400. The CSI-AssociatedReportConfigInfo 400 may be associated with aperiodic resources for CSI reports.

The CSI-AssociatedReportConfigInfo 400 may be associated with a CSI report configuration. For example, the CSI-AssociatedReportConfigInfo 400 may include a CSI-ReportConfigId of a CSI-ReportConfig.

The CSI-AssociatedReportConfigInfo 400 may include a parameter for allocating resources for measurement or reporting. The resources may include NZP-CSI-RS resource set, and transmission configuration indicator (TCI) state. For example, resourcesForChannel-r19 410 field may configure the resource sets associated with one or more TRSs. The resourcesForChannel-r19 410 may configure NZP-CSI-RS resources. The TCI state, determined by TCI-StateId in resourcesForChannel-r19, may be applied to all configured NZP-CSI-RS resources configured by the resourcesForChannel-r19 410.

3GPP TSs describe operations that rely on transmission configuration indicator (TCI) states to facilitate communications. A TCI state may define a quasi-co-location (QCL) relationship between a source and a target.

The network may configure one or both of the resourceForChannel and resourceForChannel-r19.

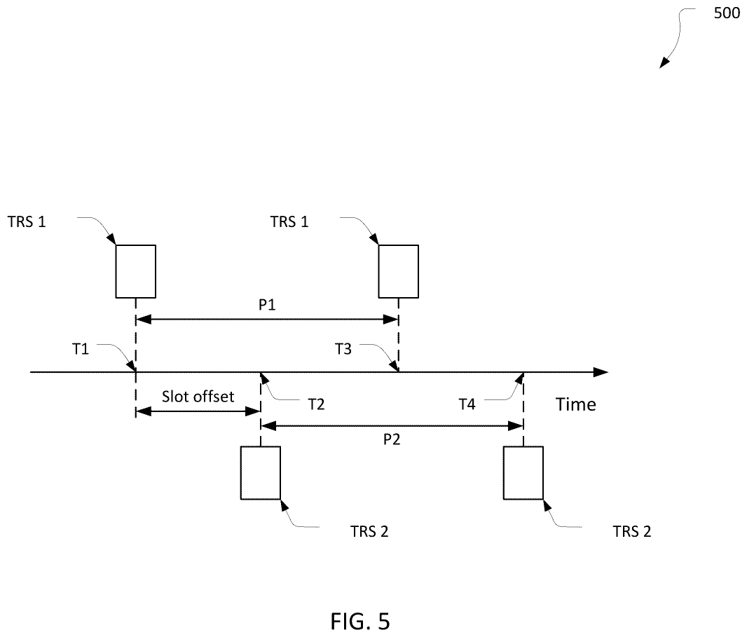

FIG. 5 illustrates a timing diagram 500 in accordance with some embodiments. The UE may be configured with periodic TRS 1 associated with one TRP and periodic TRS 2 associated with another TRP.

At time T1, TRS 1 is transmitted from the first TRP (or received at the UE). The first TRP again transmits the TRS 1 at T3. The time difference between T1 and T3, P1, may be the period of the periodic TRS 1.

At time T2, TRS 2 is transmitted from the second TRP (or received at the UE). The second TRP again transmits the TRS 2 at T4. The time difference between 2 and T4, P2, may be the period of the periodic TRS 2.

In some instances, TRS 1 and TRS 2 have the same periodicity. The period of TRS 1 and TRS 2 may be the same, e.g., P1=P2. In some instances, the period of TRS 1 and TRS 2 may be different, e.g., P1>P2 or P2>P1. When the period of TRS 1 and TRS 2 are different, the period of TRS 1 may be an integer multiple of the period of TRS 2, e.g., P1=k·P2, where k=1, 2, 3, 4, . . . .

The relative slot offset between TRS 1 and TRS 2 may be the time between TRS 1 and TRS 2 transmission, e.g., T2−T1. The relative slot offset may be calculated with reference to the earliest TRS resource set. The slot offset between TRSs may be smaller than a threshold or may take predefined values. For example, the relative slot offset between TRSs may be smaller than 0, 1, 2, or 3 slots. In another example, the relative slot offset between TRSs may take value from a set {0, 1, 2, 3} slots. The network may configure the predefined value or the threshold for the relative slot offset between TRSs.

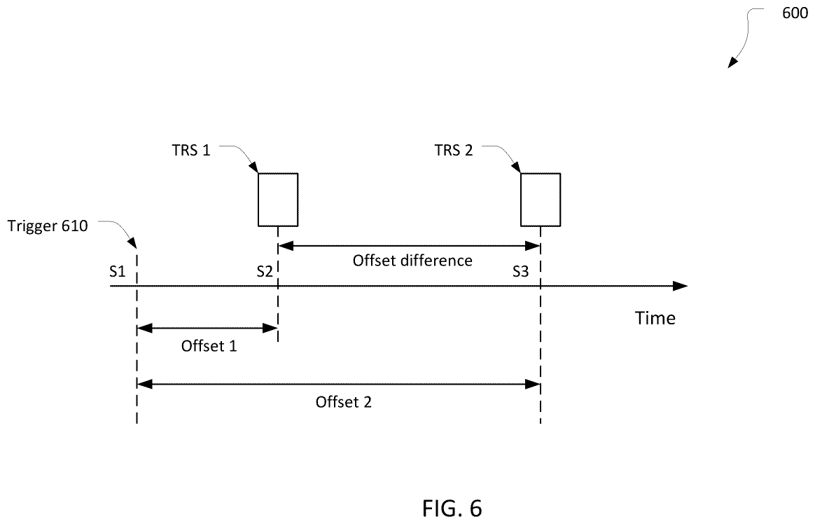

FIG. 6 illustrates a timing diagram 600 in accordance with some embodiments. The UE may be configured with aperiodic TRS 1 associated with one TRP and periodic TRS 2 associated with another TRP.

At time S1, the UE may receive a trigger 610 for measuring and reporting timing or frequency offset between two TRPs. For example, trigger 610 may be a DCI. The DCI for aperiodic TRS may include an offset. The offset may determine the time after receiving the trigger 610 that the UE may expect to receive the TRS. For example, trigger 610 may trigger both TRS 1 and TRS 2 at S1, and it may include offset 1 associated with TRS 1 and offset 2 associated with TRS 2. The TRP 1 may transmit TRS 1 at S2=S1+Offset 1, and TRP 2 may transmit TRS 2 at S3=S1+Offset 2. The time difference between TRS 2 and TRS 1 transmission, e.g., S3−S1, is the relative offset difference between TRS 1 and TRS 2. The relative offset difference between TRSs may be calculated with reference to the earliest TRS resource set.

The relative offset difference between TRSs may be smaller than a threshold or may take predefined values. For example, the relative offset difference between TRSs may be smaller than 0, 1, 2, or 3 slots. In another example, the relative offset difference between TRSs may take value from a set {0, 1, 2, 3} slots. The network may configure the predefined value or the threshold for the relative offset difference between TRSs.

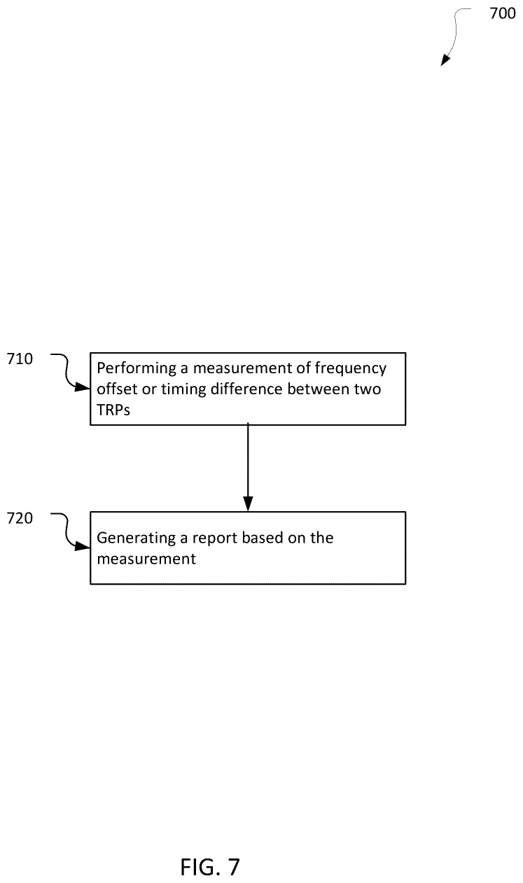

FIG. 7 illustrates an operational flow/algorithmic structure 700 in accordance with some embodiments. Operational flow/algorithmic structure 700 is an example of the UE measuring and reporting timing difference or frequency offset between multiple TRPs. The operation flow/algorithmic structure 700 may be implemented by a UE (for example, UE 104 or UE 900) or components therein, for example, processing circuitry 904.

The operation flow/algorithmic structure 700 may include, at 710, performing a measurement of frequency offset or timing difference between two TRPs. The UE may measure the TRSs associated with each TRP. The UE may receive a configuration from the base station that configures multiple TRP resources or TRP resource sets. The TRP resource sets may be periodic, aperiodic, or semi-persistent resource sets. The TRS resource sets may be NZP-CSI-RS resource sets.

The operation flow/algorithmic structure 700 may include, at 720, generating a report based on the measurement. The report may be a stand-alone report that only carries indications associated with the measured frequency offset or timing difference. The report may be a non-stand-alone report that may simultaneously include frequency offset or timing difference information and CSI quantities such as L1 RSRP, L1 SINR, CQI, PMI, RI, LI, or tdcp.

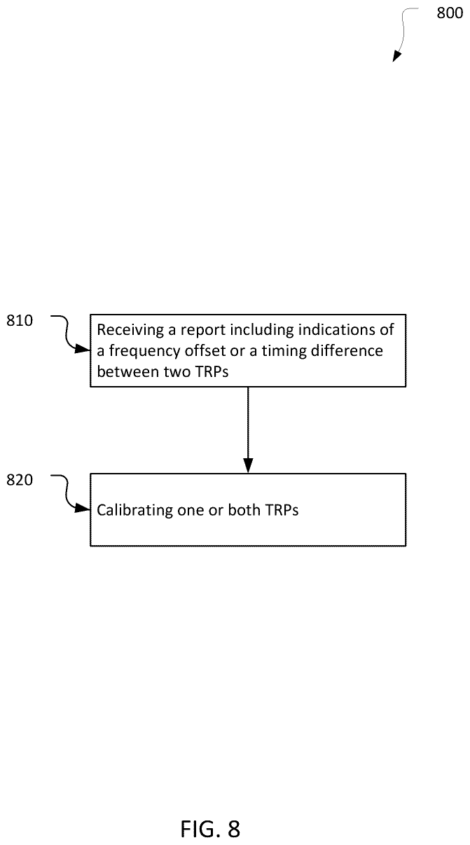

FIG. 8 illustrates an operational flow/algorithmic 800 structure in accordance with some embodiments. Operational flow/algorithmic structure 800 is an example of the operation of the base station 108. The operational flow/algorithmic structure 800 may be implemented by a network node, for example, the network node 1000, or components therein, e.g., processors 1004.

The operation flow/algorithmic structure 800 may include, at 810 receiving, from a UE, a report including a frequency offset between two or more TRPs or a timing difference between two or more TRPs. The report may be a CSI report.

The operation flow/algorithmic structure 800 may include, at 820, calibrating one or both TRPs. The network may send a command to trigger the calibration or may directly calibrate the transmission parameters of the TRPs.

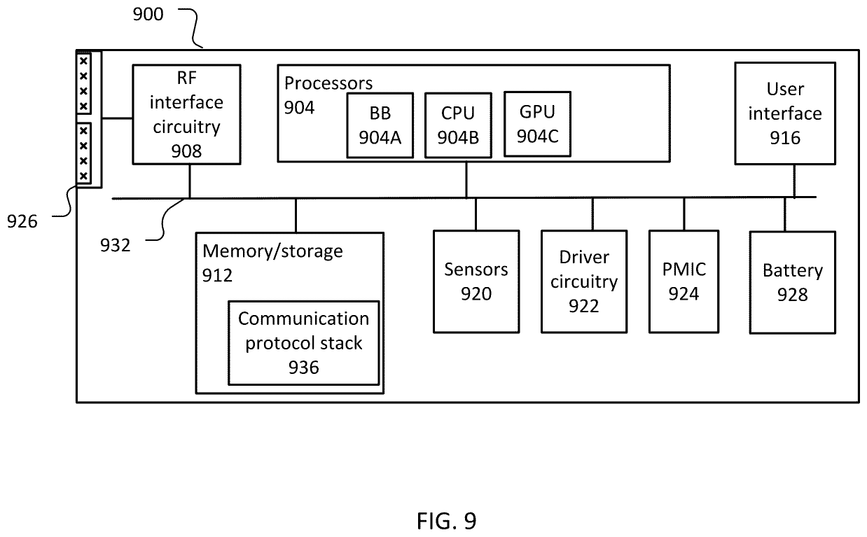

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface circuitry (for example, processor interface or memory interface), input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 912 may include one or more non-transitory, computer-readable media that includes instructions (for example, the communication protocol stack 936) that may be executed by one or more of the processors 904 to cause the UE 900 to perform various operations described herein. The memory/storage 912 includes any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processor 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands, including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within or connected to the UE 900. For example, the driver circuitry 922 may include circuitry to facilitate the coupling of a universal integrated circuit card (UICC) or a universal subscriber identity module (USIM) to the UE 900. For additional examples, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage the power provided to various components of the UE 900. In particular, with respect to the processors 904, the PMIC 924 may control power-source selection, voltage scaling, battery charging, or DC-to-DC conversion.

In some embodiments, the PMIC 924 may control or otherwise be part of various power-saving mechanisms of the UE 900, including DRX, as discussed herein.

A battery 928 may power the UE 900, although in some examples, the UE 900 may be mounted and deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

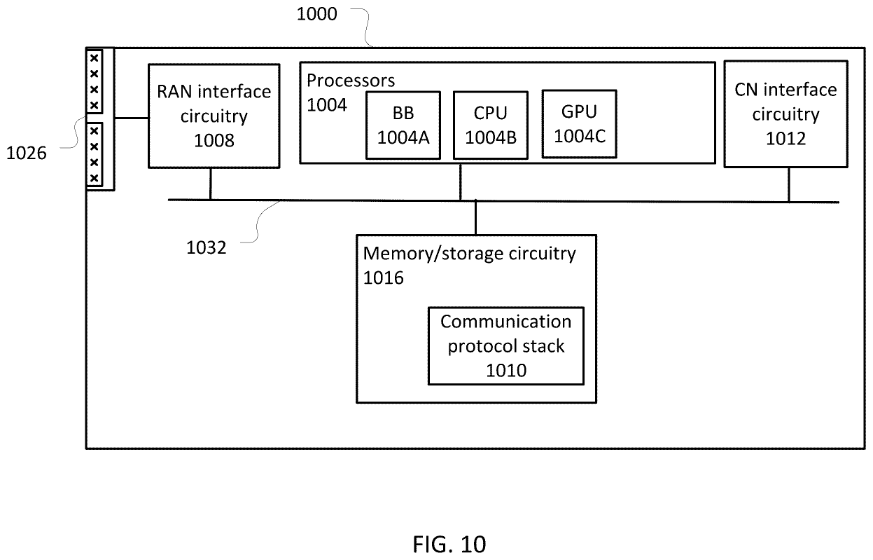

FIG. 10 illustrates a network node 1000 in accordance with some embodiments. The network node 1000 may be similar to and substantially interchangeable with base station 108, a device implementing one of the network hops, an integrated access and backhaul (IAB) node, a network-controlled repeater, or a server in a core network or external data network.

The network node 1000 may include processors 1004, RF interface circuitry 1008 (if implemented as an access node), the core node (CN) interface circuitry 1012, memory/storage circuitry 1016, and antenna structure 1026.

The components of the network node 1000 may be coupled with various other components over one or more interconnects 1032.

The processors 1004, RF interface circuitry 1008, memory/storage circuitry 1016 (including communication protocol stack 1010), antenna structure 1026, and interconnects 1032 may be similar to the like-named elements shown and described with respect to FIG. 9.

The CN interface circuitry 1012 may provide connectivity to a core network, for example, a 5th Generation Core network (5GC) using a 5GC-compatible network interface protocol such as carrier Ethernet protocols or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit-receive points (TRPs) using the antenna structure 1026, CN interface circuitry, or other interface circuitry.

It is well understood that the use of personally identifiable information should follow privacy policies and practices generally recognized as meeting or exceeding industry or governmental requirements for maintaining users' privacy. In particular, personally identifiable information data should be managed and handled to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method to be implemented by a component of a user equipment (UE), the method includes: performing a measurement of a frequency offset between a first transmit-receive point (TRP) and a second TRP or a timing difference between a first TRP and a second TRP; and generating a report based on the measurement.

Example 2 includes the method of example 1 or other examples herein, further including: processing a configuration associated with the measurement or the report.

Example 3 includes the method of examples 1 or 2 or other examples herein, wherein the configuration includes a channel measurement resource (CMR) configuration, the CMR configuration associated with the measurement.

Example 4 includes the method of any of examples 1-3 or other examples herein, wherein the configuration includes a tracking reference signal (TRS) resource, the TRS resource associated with the measurement.

Example 5 includes the method of any of examples 1˜4 or other examples herein, wherein the configuration includes a tracking reference signal (TRS) resource set, the TRS resource set associated with the measurement.

Example 6 includes the method of any of examples 1-5 or other examples herein, wherein the TRS resource set is a non-zero-power channel state information resource set.

Example 7 includes the method of any of examples 1-6 or other examples herein, wherein: the TRS resource set is a first TRS resource set, the first TRS resource set is a first periodic TRS resource set or a first aperiodic TRS resource set; and the configuration includes a second TRS resource set, the second TRS resource set is a second periodic TRS resource set or a second aperiodic TRS resource set.

Example 8 includes the method of any of examples 1-7 or other examples herein, wherein: the first TRS resource set is a first periodic TRS resource set and the first periodic TRS resource set is a first non-zero-power (NZP) channel state information (CSI) reference signal (RS) resource set; the second TRS resource set is a second periodic TRS resource set and the second periodic TRS resource set is a second NZP-CSI-RS resource set; and the first NZP-CSI-RS resource set and the second NZP-CSI-RS resource set are configured by a CSI resource configuration.

Example 9 includes the method of any of examples 1-8 or other examples herein, wherein the CSI resource configuration includes a channel measurement resource (CMR) configuration.

Example 10 includes the method of any of examples 1-9 or other examples herein, wherein the first period is the periodicity of the first periodic TRS, the second period is the periodicity of the second periodic TRS, and the first period is an integer multiple of the second period.

Example 11 includes the method of any of examples 1-10 or other examples herein, wherein a relative slot offset between the first periodic TRS resource set and the second periodic TRS resource set is a predefined value.

Example 12 includes the method of any of examples 1-11 or other examples herein, wherein the predefined value is 0, 1, 2, or 3 slots.

Example 13 includes the method of any of examples 1-12 or other examples herein, wherein: the first TRS resource set is a first aperiodic TRS resource set and the first aperiodic TRS resource set is a first non-zero-power (NZP) channel state information (CSI) reference signal (RS) resource set; the second TRS resource set is a second aperiodic TRS resource set and the second aperiodic TRS resource set is an NZP-CSI-RS resource set; and the first NZP-CSI-RS resource set and the second NZP-CSI-RS resource set are configured by a CSI resource configuration.

Example 14 includes the method of any of examples 1-13 or other examples herein, wherein a relative triggering offset between a first trigger associated with the first aperiodic TRS resource set and a second trigger associated with the second aperiodic TRS resource set is a predefined value.

Example 15 includes the method of any of examples 1-14 or other examples herein, wherein the predefined value is 0, 1, 2, or 3 slots.

Example 16 includes the method of any of examples 1-15 or other examples herein, wherein the measurement is a measurement of a frequency offset between a first TRP and a second TRP, the first TRP is a reference TRP, and the report is based on a frequency offset of the second TRP.

Example 17 includes the method of any of examples 1-16 or other examples herein, wherein the measurement is a measurement of a time offset between a first TRP and a second TRP, the first TRP is a reference TRP, and the report is based on a time offset of the second TRP.

Example 18 includes a method to be implemented by a component of a network element, the method including: receiving, from a user equipment (UE), a report including indications of a frequency offset between a first transmit-receive point (TRP) and a second TRP or a timing difference between a first TRP and a second TRP; and calibrating the first TRP or the second TRP.

Example 19 includes the method of example 18 or other examples herein, the method further including: sending, to the UE, a configuration message including an indication of resources associated with the report.

Example 20 includes the method of examples 18 or 19 or other examples herein, wherein the resources are resources of a periodic channel state information (CSI) report or an aperiodic CSI report.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include an apparatus comprising: processing circuitry to perform one or more elements of the method described in or related to any of examples 1-20, or any other method or process described herein; and interface circuitry, coupled with the processing circuitry, the interface circuitry to communicatively couple the processing circuitry to one or more components of a computing platform.

Another example includes a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
performing a measurement of a frequency offset or timing offset between a first transmit-receive point (TRP) and a second TRP; and
generating a report based on the measurement.

2. The method of claim 1, further comprising:
processing a configuration associated with the measurement or the report.

3. The method of claim 2, wherein:
the configuration includes a channel measurement resource (CMR) configuration associated with the measurement; and
the configuration includes a tracking reference signal (TRS) resource set associated with the measurement.

4. The method of claim 3, wherein the TRS resource set is a non-zero-power (NZP) channel state information (CSI) reference signal (RS) resource set.

5. The method of claim 3, wherein:
the configuration is a channel state information (CSI) configuration;
the TRS resource set is a first TRS resource set, the first TRS resource set is a first periodic TRS resource set or a first aperiodic TRS resource set; and
the configuration includes a second TRS resource set, the second TRS resource set is a second periodic TRS resource set or a second aperiodic TRS resource set.

6. The method of claim 5, wherein:
the first TRS resource set is associated with the first TRP; and
the second TRS resource set is associated with the second TRP.

7. The method of claim 1, wherein the measurement is a measurement of a frequency offset between a first TRP and a second TRP, the first TRP is a reference TRP, and said generating a report comprises:
differentially encoding a frequency offset of the second TRP with respect to a frequency offset of the first TRP.

8. The method of claim 1, wherein the measurement is a measurement of a frequency offset between a first TRP and a second TRP, the first TRP is a reference TRP, and the method further comprises:
calculating a frequency offset of the second TRP with respect to the first TRP; and
determining an absolute value of the frequency offset, wherein the report includes an indication of the first TRP and the absolute value of the frequency offset.

9. The method of claim 1, wherein the measurement is a measurement of a timing offset between a first TRP and a second TRP, the first TRP is a reference TRP, and said generating a report comprises:
differentially encoding the timing offset of the second TRP with respect to the first TRP.

10. The method of claim 1, wherein the measurement is a measurement of a timing offset between a first TRP and a second TRP, the first TRP is a reference TRP, and the method further comprises:
calculating the timing offset of the second TRP with respect to the first TRP; and
determining an absolute value of the timing offset, wherein the report includes an indication of the first TRP and the absolute value of the timing offset.

11. An apparatus comprising:
processing circuitry to:
perform a measurement of a frequency offset or timing offset between a first transmit-receive point (TRP) and a second TRP; and
generate a report based on the measurement; and
interface circuitry coupled with the processing circuitry, the interface circuitry to communicatively couple the processing circuitry with a component.

12. The apparatus of claim 11, wherein the processing circuitry is further to:
process a configuration associated with the measurement or the report, wherein the configuration includes a tracking reference signal (TRS) resource set.

13. The apparatus of claim 12, wherein:
the configuration is a channel state information (CSI) configuration;
the TRS resource set is a first TRS resource set associated with the first TRP, the first TRS resource set is a first periodic TRS resource set or a first aperiodic TRS resource set; and
the configuration includes a second TRS resource set associated with the second TRP, the second TRS resource set is a second periodic TRS resource set or a second aperiodic TRS resource set.

14. The apparatus of claim 11, wherein the measurement is a measurement of a frequency offset between a first TRP and a second TRP, the first TRP is a reference TRP, and to generate a report the processing circuitry is to:
differentially encode a frequency offset of the second TRP with respect to a frequency offset of the first TRP.

15. The apparatus of claim 11, wherein the measurement is a measurement of a frequency offset between a first TRP and a second TRP, the first TRP is a reference TRP, and the processing circuitry is further to:
calculate a frequency offset of the second TRP with respect to the first TRP; and
determine an absolute value of the frequency offset, wherein the report includes an indication of the first TRP and the absolute value of the frequency offset.

16. The apparatus of claim 11, wherein the measurement is a measurement of a timing offset between a first TRP and a second TRP, the first TRP is a reference TRP, and to generate a report the processing circuitry is to:
differentially encode the timing offset of the second TRP with respect to the first TRP.

17. The apparatus of claim 11, wherein the measurement is a measurement of a timing offset between a first TRP and a second TRP, the first TRP is a reference TRP, and the processing circuitry is further to:
calculate the timing offset of the second TRP with respect to the first TRP; and
determine an absolute value of the timing offset, wherein the report includes an indication of the first TRP and the absolute value of the timing offset.

18. One or more non-transitory, computer-readable media having instructions that are to be executed to cause processing circuitry to:
process a report, received from a user equipment (UE), including indications of a frequency offset between a first transmit-receive point (TRP) and a second TRP or a timing offset between a first TRP and a second TRP; and
calibrate the first TRP or the second TRP.

19. The one or more non-transitory, computer-readable media of claim 18, wherein the instructions are to be executed to further cause the processing circuitry to:
generating, for transmitting to the UE, a configuration message including an indication of resources associated with the report.

20. The one or more non-transitory, computer-readable media of claim 19, wherein the report includes a differentially encoded timing offset or a differentially encoded frequency offset.
